(19) United States
(12) Patent Application Publication
(10) Pub. No.: US 2018/0330373 A1
(43) Pub. Date: Nov. 15, 2018

(54) METHOD AND SYSTEM OF PROVIDING ENVELOPE BUDGETING USING PAYMENT ACCOUNT TRANSACTION SYSTEM

(71) Applicant: Mastercard International Incorporated, Purchase, NY (US)

(72) Inventor: Carl D. JANSSON, St. Charles, MO (US)

(73) Assignee: Mastercard International Incorporated, Purchase, NY (US)

(21) Appl. No.: 15/591,631

(22) Filed: May 10, 2017

(51) Int. Cl. G06Q 20/40; G06Q 40/00

(52) U.S. Cl. CPC G06Q 20/405; G06Q 40/00

(57) ABSTRACT

A method for account budgeting via authorization holds includes: storing an account profile, the profile including an account identifier and a primary account number; receiving a budgeting request including the account identifier, a category identifier, and a budgeted amount; transmitting a first transaction message for a payment transaction, wherein the transaction message includes data elements configured to store the primary account number and the budgeted amount; receiving a release request including the account identifier, the category identifier, and a release amount; and transmitting a second transaction message for the payment transaction including the release amount.

### FIELD

The present disclosure relates to envelope-style account budgeting, specifically the use of authorization holds to accomplish envelope-style account budgeting in a transaction account without the use of additional transaction accounts or the transfer of funds.

### BACKGROUND

For many individuals and other entities, budgeting is a beneficial tool that can ensure that their money is not misused, and that will not overspend in one category to their detriment in another. Traditionally, many budgeting tools rely on the willpower of the account holder or other user of a transaction account: their budget may say they can only spend a certain amount in a certain category, but it is up to the individual to actually ensure that they do not overspend.

In order to increase the protection of a budget, some systems have been developed that utilize multiple transaction accounts for budgeting. For example, when an individual wants to set aside money for a specific category or purchase, the money is transferred to a different account, which makes it unusable without the associated payment instrument. In such an instance, the individual may not regularly carry the payment instrument for the different account, reducing the likelihood that they will impulsively spend the money. However, such a system requires multiple transaction accounts, which may be inconvenient or impractical for some individuals, and may also make it more difficult for the individual to keep track of general accounting as more and more accounts are used for savings in various categories.

In an effort to solve the problems of using multiple transaction accounts, some systems have been developed that utilize transaction controls, such as described in U.S. patent application Ser. No. 12/251,492, entitled “Method and System for Periodic Saving Using Account Controls,” filed on Aug. 30, 2016, which is herein incorporated by reference in its entirety. However, such methods rely on transaction accounts that are configured for usage of transaction controls, which may be unavailable for some transaction accounts.

Thus, there is a need for a technical solution that enables the use of envelope-style budgeting with a single transaction account that does not require the use of additional transaction accounts or the use of transaction controls.

### SUMMARY

The present disclosure provides a description of systems and methods for account budgeting via the use of authorization holds. Authorization holds are existing tools that are used to place holds on money in a transaction account prior to clearing. The use of an authorization hold may ensure that a specific amount of money in a transaction account may be untouched (and thus saved) as long as the hold is in place, enabling an individual to establish an envelope-style budget for their account, without requiring the use of additional transaction accounts or account controls for this purpose, though they could be used in parallel depending on implementation. Furthermore, as authorization holds are currently understood by issuing banks and other financial institutions, the methods and systems discussed herein may be implemented with a minimal, if any, amount of modification to existing financial institution systems, which may increase the availability and adoption of such methods.

A method for account budgeting via authorization holds includes: storing, in an account database of a processing server, an account profile, wherein the account profile is a structured data set related to a transaction account and includes at least an account identifier and a primary account number; receiving, by a receiving device of the processing server, a budgeting request, wherein the budgeting request includes at least the account identifier, a category identifier, and a budgeted amount; electronically transmitting, by a transmitting device of the processing server, a first transaction message for a payment transaction, wherein the transaction message is formatted based on one or more standards and includes a plurality of data elements including at least a first data element configured to store the primary account number and a second data element configured to store the budgeted amount; receiving, by the receiving device of the processing server, a release request, wherein the release request includes at least the account identifier, the category identifier, and a release amount; and electronically transmitting, by the transmitting device of the processing server, a second transaction message for the payment transaction, wherein the second transaction message includes at least the release amount.

A system for account budgeting via authorization holds includes: an account database of a processing server configured to store an account profile, wherein the account profile is a structured data set related to a transaction account and includes at least an account identifier and a primary account number; a receiving device of the processing server configured to receive a budgeting request, wherein the budgeting request includes at least the account identifier, a category identifier, and a budgeted amount; and a transmitting device of the processing server configured to electronically transmit a first transaction message for a payment transaction, wherein the transaction message is formatted based on one or more standards and includes a plurality of data elements including at least a first data element configured to store the primary account number and a second data element configured to store the budgeted amount, wherein the receiving device of the processing server is further configured to receive a release request, wherein the release request includes at least the account identifier, the category identifier, and a release amount, and the transmitting device of the processing server is further configured to electronically transmit a second transaction message for the payment transaction, wherein the second transaction message includes at least the release amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for account budgeting via authorization holds in accordance with exemplary embodiments.

FIG. 2 is a block diagram illustrating the processing server of FIG. 1 for the use of authorization holds to provide for account budgeting in accordance with exemplary embodiments.

FIG. 3 is a flow diagram illustrating a process for the establishing and usage of envelope-style budgeting in the system of FIG. 1 in accordance with exemplary embodiments.

FIG. 4 is a graphic user interface illustrating the management of an account budget in the system of FIG. 1 in accordance with exemplary embodiments.

FIG. 5 is a flow chart illustrating an exemplary method for account budgeting via authorization holds in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### System for Account Budgeting Via Authorization Holds

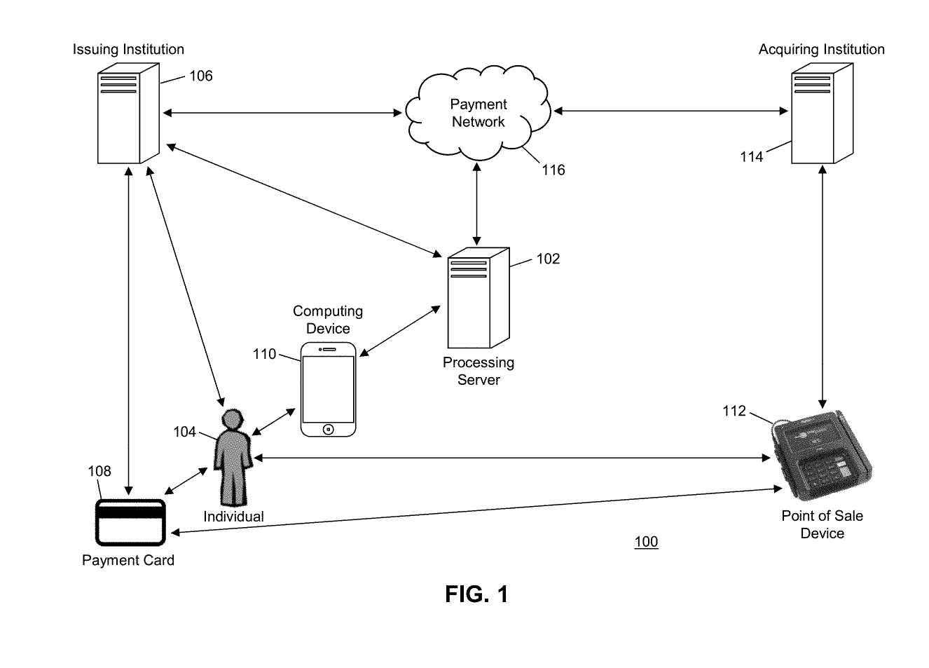

FIG. 1 illustrates a system 100 for providing envelope-style account budgeting for a transaction account using authorization holds. Traditionally, a form of account budgeting for individuals and other entities utilized envelopes, where cash would be placed into envelopes that were labeled with specific spending categories (e.g., “clothing,” “bills,” “rent,” “entertainment,” etc.). If the individual wanted to use money allotted to a specific category, they had to physically remove the money from that envelope, which requires a conscious effort by the individual if they want to use the money allotted to one category for a purchase in another category. Traditionally, such a method could only be performed with physical currency, or via the use of multiple transaction accounts, with each account operating as a separate envelope.

In the present system 100, the system 100 may include a processing server 102. The processing server 102, discussed in more detail below, may be configured to provide for envelope-style budgeting in a transaction account without the use of transaction controls or multiple transaction accounts. In the system 100, an individual 104 may have a transaction account issued thereto by an issuing institution 106. The issuing institution 106 may be a financial institution, such as an issuing bank, or other entity configured to issue transaction accounts for use in funding electronic payment transactions. The issuing institution 106 may issue a transaction account to the individual 104, which may be used by the individual 104 in electronic payment transactions initiated thereby. As part of the issuing of the transaction account, the issuing institution 106 may issue a payment card 108 or other payment instrument to the individual 104, which may be used to convey payment details for the transaction account for use in an electronic payment transaction.

The individual 104 may register their transaction account with the processing server 102 in order to utilize the account budgeting provided thereby. Registration of the transaction account may include the conveyance of payment details for the transaction account to the processing server 102. In some embodiments, the individual 104 may use a computing device 110 to execute an application program or navigate to a web page associated with the processing server 102, access an application programming interface associated with the processing server 102, or otherwise communicate with the processing server 102 for the conveyance of payment details thereto. The computing device 110 may be any type of computing device suitable for performing the functions discussed herein, such as a desktop computer, laptop computer, notebook computer, tablet computer, cellular phone, smart phone, smart watch, smart television, wearable computing device, implantable computing device, etc.

The individual 104 may, using the computing device 110, provide payment details to the processing server 102 using any suitable communication network and method. The payment details may include at least a primary account number for the transaction account, and may also include any additional data necessary for usage in an electronic payment transaction associated therewith, such as a personal identification number, payment cryptograms, transaction counters, etc. The processing server 102 may establish an account profile for the transaction account, discussed in more detail below.

Once registered, the individual 104 may be able to create budgets for multiple categories. Budgets may be created using a graphical user interface of the computing device 110, which may be accessed via an application program associated with the processing server 102 and executed by the computing device 110, a web page associated with the processing server 102 accessed using a web browsing application program, or other suitable method. In some cases, the individual 104 may use the same interface used to register the transaction account to establish budgets for their transaction account.

To create a budget, the individual 104 may specify an amount to be budgeted, as well as a category identifier for the category to which the budgeted amount applies. In some cases, the category identifier may be a name or other unique value set by the individual 104, such as for reference of the associated budget. For example, the individual 104 may establish a category of “Restaurants,” for money to be saved for use when dining out at a restaurant. In some embodiments, the processing server 102 may provide one or more default category identifiers for selection by the individual 104. In some cases, the individual 104 may be able to customize budgeting categories, such as may be used to fit their own personalized needs. For example, an individual 104 living in a dense, urban area may want to establish a budget specifically for parking costs or public transportation expenses, or a sports enthusiast may want to establish a budget specifically for the purchase of season tickets every year for their local sports team.

The individual 104 may use the computing device 110 to select a category identifier and the budgeted amount, which may then be electronically transmitted to the processing server 102 using a suitable communication network and method, such as a cellular communication network, a local area network, radio frequency, or the Internet. The category identifier and budgeted amount may also be accompanied by an account identifier associated with the individual's account profile, which may be the primary account number for the registered transaction account, or may be a separate identification value, such as may be generated for the transaction account by the processing server 102 or individual 104 during the registration process. For example, the account identifier may be a username, password, e-mail address, telephone number, identification number, registration number, device identifier (e.g., associated with the computing device 110), etc. The processing server 102 may receive the account identifier, which may be used to identify the individual's account profile and the payment details stored therein.

The processing server 102 may then place an authorization hold on the related transaction account for the budgeted amount, to save the budgeted amount for the specified category. In one embodiment, the processing server 102 may electronically transmit the budgeted amount to the issuing institution 106, which may place an authorization hold for the budgeted amount on the transaction account. In some such embodiments, the processing server 102 may communicate with the issuing institution 106 via an application programming interface (API) provided thereby. In some cases, the processing server 102 may submit a transaction message to the issuing institution 106 via the API, which may then be submitted to the payment network 116 by the issuing institution 106. In other embodiments, the placing of an authorization hold may include the generation and submission of an authorization request for an electronic payment transaction to a payment network 116 for the budgeted amount. The authorization request may be a transaction message that is submitted by the processing server 102 to the payment network 116 via payment rails associated therewith, with the authorization request including at least the payment details associated with the transaction account and the budgeted amount.

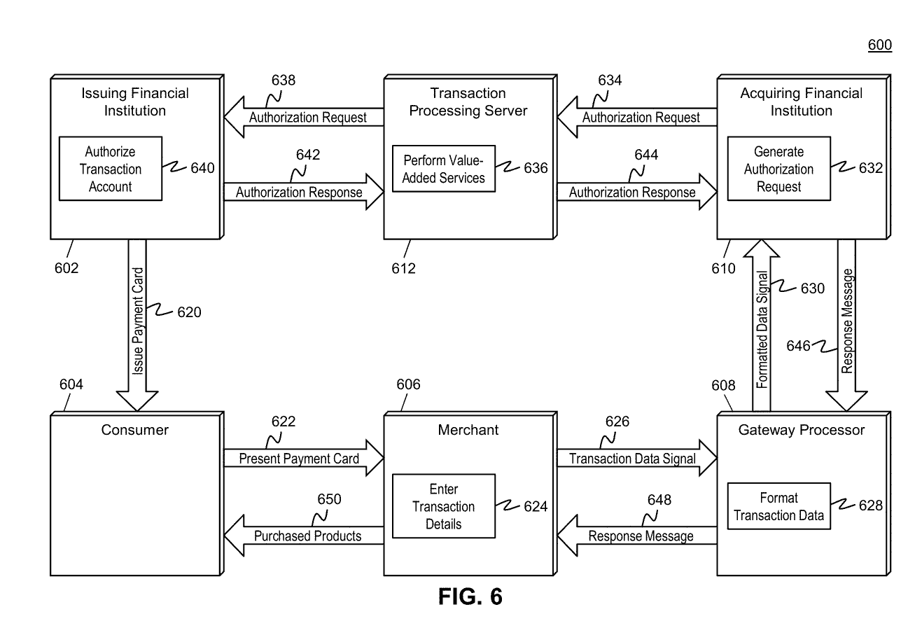

A transaction message may be specially formatted data messages that are formatted pursuant to one or more standards governing the exchange of financial transaction messages, such as the International Organization of Standardization's ISO 8583 or ISO 20022 standards. A transaction message may include at least a message type indicator that is indicative of a type of transaction message (e.g., authorization request, authorization response, account inquiry, etc.) and a plurality of data elements configured to store transaction data. Transaction data may include, for example, payment details (e.g., the primary account number and any additional data associated with the transaction account), a transaction amount (e.g., the budgeted amount), transaction time, transaction date, geographic location, currency type, point of sale device 112 type, merchant data, consumer data, account data, product data, offer data, loyalty data, etc. In some embodiments, a transaction message may also include one or more bitmaps, which may indicate the data elements included in the transaction message and the data stored therein. Additional information regarding transaction messages and use thereof in the processing of payment transactions is discussed below with respect to the process 600 illustrated in FIG. 6.

The processing server 102 (e.g., or issuing institution 106, as applicable) may submit the authorization request to the payment network 116, which may have the primary account number and other payment details, as well as the budgeted amount, stored in data elements included therein. The payment network 116 may receive the authorization request and process it using traditional methods and systems, such as discussed in the process 600 illustrated in FIG. 6 and discussed below, which may include transmission of the authorization request to the issuing institution 106. The issuing institution 106 may receive the authorization request, and, using traditional methods and systems, may determine to approve or deny the electronic payment transaction based on the data included therein. For example, the issuing institution 106 may evaluate the available credit or funds of the transaction account against the transaction amount for the transaction, and may deny the payment transaction if there is an insufficient balance in the transaction account. If approved, the issuing institution 106 may return an authorization response to the payment network 116 indicating accordingly, and may place a hold on the transaction amount in the transaction account, such that the transaction amount may not be used by the transaction account in any subsequent electronic payment transactions. In instances where the transaction message is submitted directly from the issuing institution 106, the authorization hold may be placed on the account directly by the issuing institution 106 without usage of the payment network 116, or without having the payment network 116 seek additional authorization from the issuing institution 106.

The transaction response or an indication of the approval or denial indicated therein may be forwarded to the processing server 102 from the payment network 116. If the authorization request was approved, then the budgeted amount may be held on the transaction account and thus not used by the individual 104 in any subsequent payment transactions until released. The authorization hold placed on the transaction account for the budgeted amount may be released by the issuing institution 106 (e.g., and thus the held amount made available for use by the individual 104) upon the receipt of a release message for the electronic payment transaction or after a predetermined period of time. In some embodiments, the predetermined period of time may be set by the issuing institution 106. For example, the issuing institution 106 may have a policy to release any authorization hold after seven days without the receipt of a corresponding release message.

Release messages may be submitted to the issuing institution 106 via the payment network 116, an API of the issuing institution 106, or other suitable method, and may be transaction messages or other specially formatted data messages that are associated with a specific electronic payment transaction such that, when received by the issuing institution 106, the issuing institution 106 may release the authorization hold and may transfer an amount specified in the release message to another financial institution for payment thereto. In some embodiments, the release message may be a clearing message that is a transaction message formatted accordingly, which includes at least the amount to be released and/or a reference to a prior authorization hold.

When the individual 104 wants to access money that they set aside for a particularly budgeting category, the individual 104 may submit a release request to the processing server 102 (e.g., via the computing device 110), where the release request includes their account identifier, the budgeting category for which they want to release funds, and the amount requested for release. The processing server 102 may then generate a release message that is submitted to the issuing institution 106 (e.g., via the payment network 116 or the issuing institution's API) to clear at least the amount requested for release. In some instances, the release message may be used to release the entire held amount (e.g., by cancelling the associated authorization request), and may be accompanied by a new authorization request to place a second authorization hold that is for an amount equivalent to the difference between the released amount and the originally held amount. In other words, the processing server 102 may thus replace the original authorization hold with a smaller one in order to release the amount requested by the individual 104.

The individual 104 may then use their payment card 108 at a point of sale device 112 associated with a merchant to spend the released amount. The individual 104 may present the payment card 108 to the point of sale device 112 to convey the associated payment details thereto using traditional methods, such as via a magnetic stripe included in the payment card 108, via near field communication, etc. The point of sale device 112 may receive the payment details from the payment card 108, which may be conveyed to an acquiring institution 114 with other transaction data for the payment transaction. The acquiring institution 114 may be a financial institution, such as an acquiring bank, or other entity configured to issue transaction accounts for use in receiving funds for electronic payment transactions. The acquiring institution 114 may generate and submit an authorization request for the payment transaction to the payment network 116, which may be forwarded to the issuing institution 106 and processed using traditional methods and systems.

In cases where the payment transaction initiated by the individual 104 does not meet or exceed the release amount, the individual 104 may desire for the remainder to be placed back into the “envelope” for that budgeting category. In some such cases, the individual 104 may submit a new budgeting request to the processing server 102 for the budgeting category for the remaining amount. In other cases, the processing server 102 may be configured to monitor the account activity of the registered transaction account. For example, the processing server 102 may receive transaction details for transaction accounts conducted using the registered transaction account from the payment network 116 or issuing institution 106. The processing server 102 may receive transaction details for the payment transaction initiated by the individual 104 following the release and may, if the transaction amount is less than the released amount, automatically (e.g., or upon confirmation by the individual 104, such as may be prompted by a message submitted to the computing device 110 and presented to the individual 104) submit a new authorization request or other transaction message to place an authorization hold on the remaining amount.

In some embodiments, the processing server 102 may be configured to replace authorization holds if they time out (e.g., the predetermined period of time has exceeded and the authorization hold removed). For instance, if the predetermined period of time has passed without the individual 104 releasing the money in a budgeted category, the processing server 102 may generate and submit another authorization request for that budgeted category to place a new authorization hold on the account for the budgeted amount. In such embodiments, the processing server 102 may continue to refresh authorization holds until a hold is released as instructed by the individual 104. In some instances, the individual 104 may set a time for automatic release of an authorization hold. For instance, when submitting a budgeting request, the individual 104 may specific a specific time at which the budgeted amount should be released. For example, the individual 104 may set aside a budget for a bill to be paid and may automatically schedule the budgeted amount for release the day the bill will be due for payment thereof. In such an example, when the day arrives, the processing server 102 may automatically submit a clearing record for the corresponding authorization request for release thereof.

In some embodiments, the processing server 102 may be configured to combine authorization holds for a budgeted category. For instance, the individual 104 may submit more than one budgeting request for a specific budgeted category. In such embodiments, when a budgeting request is received by the processing server 102 for a budgeting category for which an authorization hold already exists, the processing server 102 may release the authorization hold and may submit a new authorization request for a combined amount totaling the combination of the previously held amount and the new budgeted amount. In such embodiments, the transaction account may only have a single authorization hold placed thereon for each budgeting category. Such practices may be used to simplify the process for releasing funds when requested by the individual 104.

In some embodiments, the processing server 102 may be configured for to provide budgeting for multiple transaction accounts. For example, the individual 104 may register multiple transaction accounts with the processing server 102 for use with a single budgeting plan. The processing server 102 may store the payment details for each transaction account in the account profile for the individual 104. In some such embodiments, the individual 104 may set budgets individually for each transaction account. In other such embodiments, the individual 104 may set account-wide budgets, which may be applicable to all registered transaction accounts. In such embodiments, the processing server 102 may use a holding scheme that may be set by the processing server 102, or selected by the individual 104 (e.g., during registration). For instance, in a first scheme, the authorization holds for a budgeting category may be placed on each registered transaction account with an equal value (e.g., a $90 budgeted amount may be implemented via $30 holds on three registered transaction accounts). In a second scheme, authorization holds may all be placed on a specific transaction account (e.g., as indicated by the individual 104 during registration) unless an associated authorization request is denied (e.g., due to the specific transaction account hitting its credit limit), in which case authorization holds may be placed on a second transaction account in line, and so on through each registered transaction account.

The methods and systems discussed herein provide for the establishing of account budgets on a transaction account via the use of authorization holds by the processing server 102. Authorization holds may enable an individual 104 to set aside money in their transaction account without the use of additional transaction accounts, and even for transaction accounts and issuing institutions 106 that are not configured for use of transaction controls. Furthermore, as issuing institutions 106 are currently configured to receive and processing transaction messages to implement authorization holds, the methods and systems discussed herein may enable the processing server 102 to implement the discussed methods without modification to existing issuing institutions 106, which may enable an individual 104 to register with the processing server 102 and receive the benefits provided thereby with existing transaction accounts and issuing institutions 106.

### Processing Server

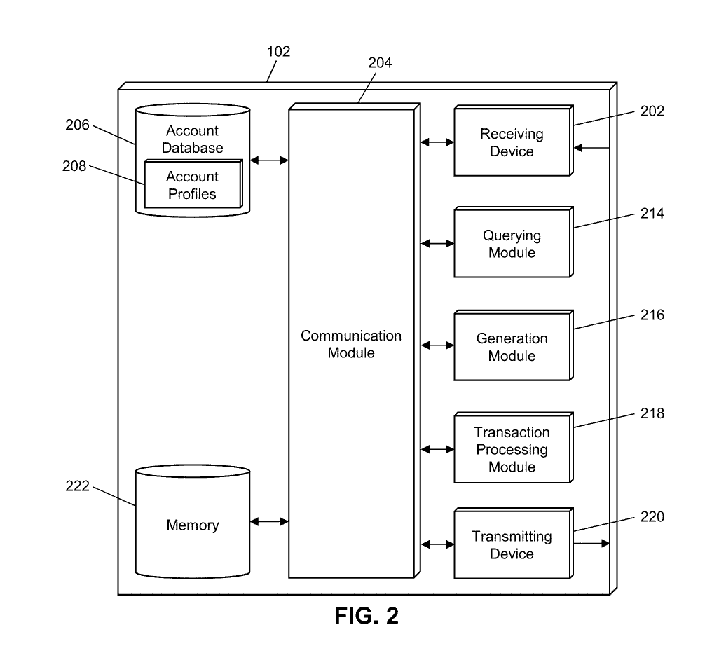

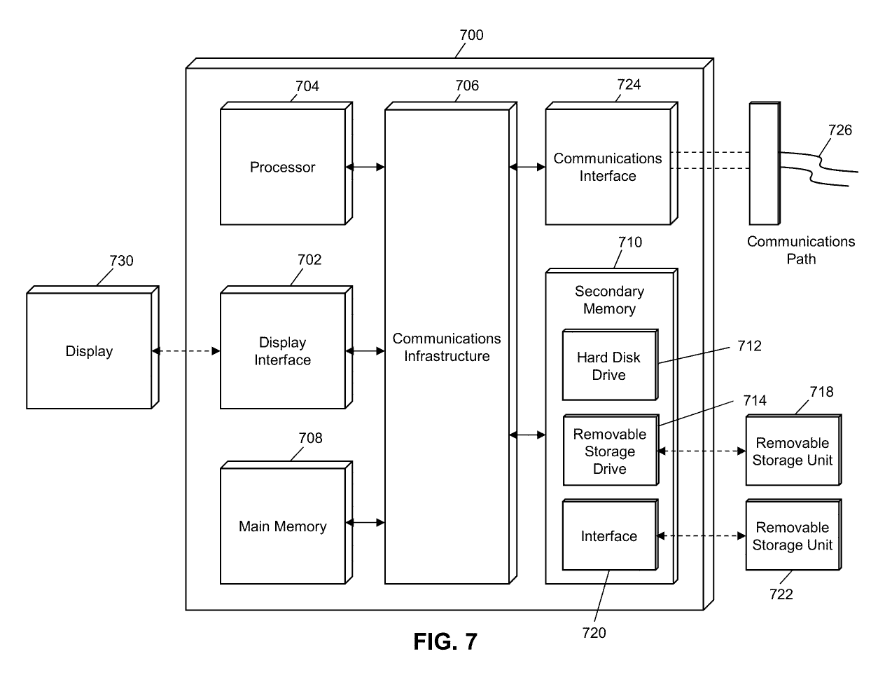

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data from issuing institutions 106, computing devices 110, payment networks 116, and other entities via one or more communication networks, such as local area networks, cellular communication networks, the Internet, etc. The receiving device 202 may also be configured to receive data over specially configured payment rails associated with the payment network 116, which may be specialized infrastructure associated therewith. In some embodiments, the receiving device 202 may be comprised of multiple devices, such as different receiving devices for receiving data over different networks, such as a first receiving device for receiving data via the payment network 116 and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 106 and/or computing devices 110, which may be superimposed or otherwise encoded with registration data, which may include at least a primary account number and other payment details associated with a transaction account. The receiving device 202 may also be configured to receive data signals electronically transmitted by computing devices 110, which may be superimposed or otherwise encoded with budgeting requests and release requests, for the establishing or releasing, respectively, of authorization holds for budgeting categories for a specific transaction account. In some embodiments, the receiving device 202 may also be configured to receive data signals that are superimposed or otherwise encoded with transaction messages, which may be electronically transmitted via payment rails by issuing institutions 106 and/or payment networks 116.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, transaction processing module 218, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. An account profile 208 may include at least a primary account number and associated payment details, and an account identifier. In some embodiments, the account identifier and the primary account number may be the same value. The account profile 208 may also include budgeting categories and associated budgeted amounts once established by the corresponding individual 104. In some embodiment, the account profile 208 may also include data associated with current authorization holds placed on the related transaction account. For instance, the account profile 208 may include transaction amounts and other data to be included in clearing messages for authorization requests for the related transaction account, such as transaction identifiers, transaction times and dates, etc.

The processing server 102 may include a querying module 214. The querying module 214 may be configured to execute queries on databases to identify information. The querying module 214 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify an account profile 208 related to a transaction account for which a budgeting request or release request is received via an account identifier included therein.

The processing server 102 may also include a generation module 216. The generation module 216 may be configured to generate data for the processing server 102 for performing of the functions associated therewith as discussed herein. The generation module 216 may receive instructions for data to be generated as input, which may be accompanied with data to be used in the generation, may generate the requested data, and may output the generated data to another module or engine of the processing server 102. For example, the generation module 216 may be configured to generate authorization requests, clearing messages, and other transaction messages for use in placing or removing authorization holds for envelope-based budgeting using the methods discussed herein. In some embodiments, the generation module 216 may also be configured to generate data messages for transmission to the computing device 110, such as may include notifications regarding budgeted amounts, received transaction activity, etc.

The processing server 102 may also include a transaction processing module 218. The transaction processing module 218 may be configured to perform the functions of the processing server 102 related to the processing of payment transactions as discussed herein, such as the receipt and parsing of data stored in the data elements included in a transaction message received by the receiving device 202. In some embodiments, the processing server 102 may be a part of the payment network 116. In such embodiments, the processing server 102 may be configured to perform traditional functions related to the processing of payment transactions, such as fraud scoring, account mapping, stand-in processing, etc.

The processing server 102 may also include a transmitting device 220. The transmitting device 220 may be configured to transmit data over one or more networks via one or more network protocols. In some embodiments, the transmitting device 220 may be configured to transmit data to computing devices 110, issuing institutions 106, payment networks 116, and other entities via one or more networks, such as local area networks, cellular communication networks, the Internet, payment rails, etc. The transmitting device 220 may also be configured to transmit data over specially configured payment rails associated with the payment network 116, which may be specialized infrastructure associated therewith. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to payment networks 116 via payment rails associated therewith and/or directly to issuing institutions 106, which may be superimposed or otherwise encoded with authorization requests, clearing messages, and other transaction messages, used to establish and remove authorization holds for performing the processes discussed herein. In some instances, the transmitting device 220 may be configured to electronically transmit transaction messages directly to issuing institutions 106, such as via APIs associated therewith. In some embodiments, the transmitting device 220 may also be configured to electronically transmit data signals to computing devices 110, which may be superimposed or otherwise encoded with account information (e.g., current budgeting categories and their budgeted amounts), notifications (e.g., of a scheduled release of an authorization hold), prompts for instructions (e.g., for automatic re-holding of release funds if unspent), etc.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein.

### Process for Envelope Budgeting Using Authorization Holds

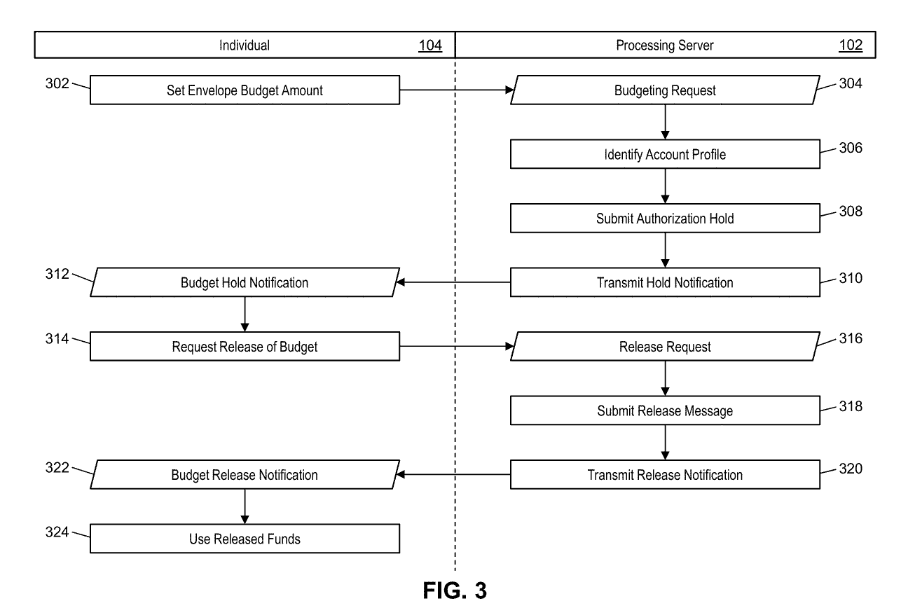

FIG. 3 illustrates a process for envelope-based budgeting in an electronic transaction account via the use of authorization holds in the system 100.

In step 302, the individual 104 may (e.g., via the computing device 110) set a budget amount for a virtual budget envelope. As part of the setting of the budget amount, the individual 104 may select a transaction account registered with the processing server 102, select a pre-existing or new budgeting category, and may select the amount to be budgeted. In step 304, the receiving device 202 of the processing server 102 may receive a budget request submitted by the individual 104 (e.g., using the computing device 110). The budget request may include at least the budgeting category and budgeted amount, as well as an account identifier associated with the selected transaction account. In step 306, the querying module 214 of the processing server 102 may execute a query on the account database 206 of the processing server 102 to identify an account profile 208 related to the selected transaction account based on the supplied account identifier.

In step 308, the generation module 216 of the processing server 102 may generate an first transaction message for an electronic payment transaction to establish an authorization hold on the selected transaction account for the budgeted amount, which may be submitted to the payment network 116 (e.g., via payment rails associated therewith) or to the issuing institution 110 (e.g., via an API associated therewith) by the transmitting device 220 of the processing server 102. The authorization request may be a transaction message formatted pursuant to one or more standards, such as the ISO 8583 or 20022 standards, which may include a message type indicator indicative of an authorization request, and a plurality of data elements including data elements configured to store at least the primary account number and other payment details included in the identified account profile 208 and the budgeted amount.

In step 310, the transmitting device 220 may electronically transmit a data message (e.g., generated by the generation module 216) to the individual 104 via their associated computing device 110 that is superimposed or otherwise encoded with a hold notification. The hold notification may indicate that the authorization hold used to hold the requested budgeted amount was placed on the selected transaction account successfully. In some embodiments, the processing server 102 may await the receipt of an authorization response for the electronic payment transaction indicating approval of the transaction, or otherwise indicating successful placement of the authorization hold, prior to the submission of the hold notification. In such embodiments, the authorization response may include a transaction identifier or other data used for identification of the corresponding authorization hold. In step 312, the individual 104 may receive the hold notification to be informed of the successful establishment of the authorization hold.

In step 314, the individual 104 may request to release at least a portion of a previously budgeted amount. As part of the request, the individual 104 may select the transaction account to which the budget pertains and the associated budgeting category, and may indicate the amount they wish to be released. The individual 104 may (e.g., via their computing device 110) submit a release request to the processing server 102, which may be received by the receiving device 202 thereof, in step 316. The release request may include the account identifier associated with the selected category, the budgeting category, and the amount to be released. In step 318, the generation module 216 of the processing server 102 may generate a release message, which may include data identifying the corresponding authorization hold (e.g., the transaction identifier or other data parsed from the authorization response, the primary account number and payment details, etc.) as well as the amount to be released, which may be submitted to the payment network 116 or directly to the issuing institution 106 by the transmitting device 220 of the processing server 102.

In step 320, the transmitting device 220 may electronically transmit a data message (e.g., generated by the generation module 216) to the individual 104 via their associated computing device 110 that is superimposed or otherwise encoded with a budget release notification. The budget release notification may be received by the individual 104 in step 322, and may indicate that the requested amount was successfully released from the budget category and is available for use in an electronic payment transaction. In step 324, the individual 104 may proceed to use the released amount in an electronic payment transaction funded via the selected transaction account. In some embodiments, the processing server 102 may be configured to detect the usage, and may be further configured to automatically hold any remaining amount or to prompt the individual 104 (e.g., via the computing device 110) for the holding of any remaining amount after usage. In some such embodiments, the processing server 102 may be configured to wait a predetermined period of time (e.g., selected by the individual 104) before prompting or automatic holding, such as to provide the individual 104 with time to conduct multiple electronic payment transactions.

### Graphical User Interface

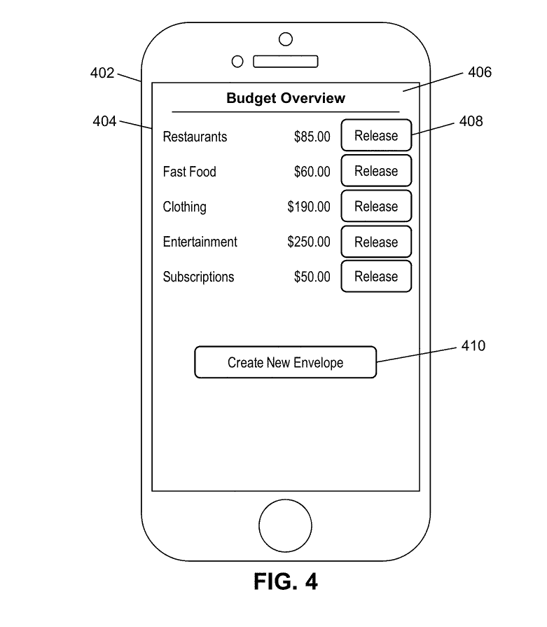

FIG. 4 illustrates an example graphical user interface of a computing device 402, which may be used as the computing device 110 in the system 100, for use by the individual 104 in performing the functions discussed herein to establish and release authorization holds for use in envelope-based budgeting with a single transaction account. It will be apparent to persons having skill in the relevant art that the interface illustrated in FIG. 4 is provided as an example illustration only, and that other suitable interfaces may be used in performing the functions discussed herein.

The computing device 402 may include a display device 404, which may be configured to display data to a user (e.g., the individual 104) of the computing device 402. The display device 404 may be any suitable type of display, such as a liquid crystal display, light-emitting diode display, thin film transistor display, capacitive touch display, etc. The display device 404 may display a budget overview 406. The budget overview 406 may provide the user with an overview of the current virtual envelopes established by the user and the ability to release funds from the envelopes as well as create new envelopes for budgeting in additional categories.

In the example illustrated in FIG. 4, the user has established five budgeting categories, each of which has a separate budgeting amount associated therewith. For instance, the user has a clothing budget of $190.00, for which a corresponding authorization hold of $190.00 has been established on their selected transaction account, which will be refreshed by the processing server 102 until release by the user. The budget overview 406 includes a release button 408 for each budgeting category. The release button 408, when interacted with by the user, may initiate the release of the budgeted amount for the corresponding budgeting category. Interaction with the release button 408 may thus submit a release request to the processing server 102 that includes the account identifier for the selected transaction account and the budgeting category and budgeted amount for the selected category. In some cases, the computing device 402 may first present a display to the user to select an amount to be released.

The budget overview 406 also includes a create new envelope button 410. The create new envelope button 410, when interacted with by the user, may present the user with options for the creation of a new budget envelope for the selected transaction account. The options may include at least an option to select a budgeting category, which may be a pre-existing category or a new category (e.g., customized by the user or selected from a predefined list, such as may be supplied by the processing server 102, and a field to enter a budgeted amount for placing in the corresponding virtual envelope. The computing device 402 may subsequently submit a budgeting request to the processing server 102 for establishing of the corresponding authorization hold. The computing device 402 may return a hold notification, which may prompt updating of the budget overview accordingly.

### Exemplary Method for Account Budgeting Via Authorization Holds

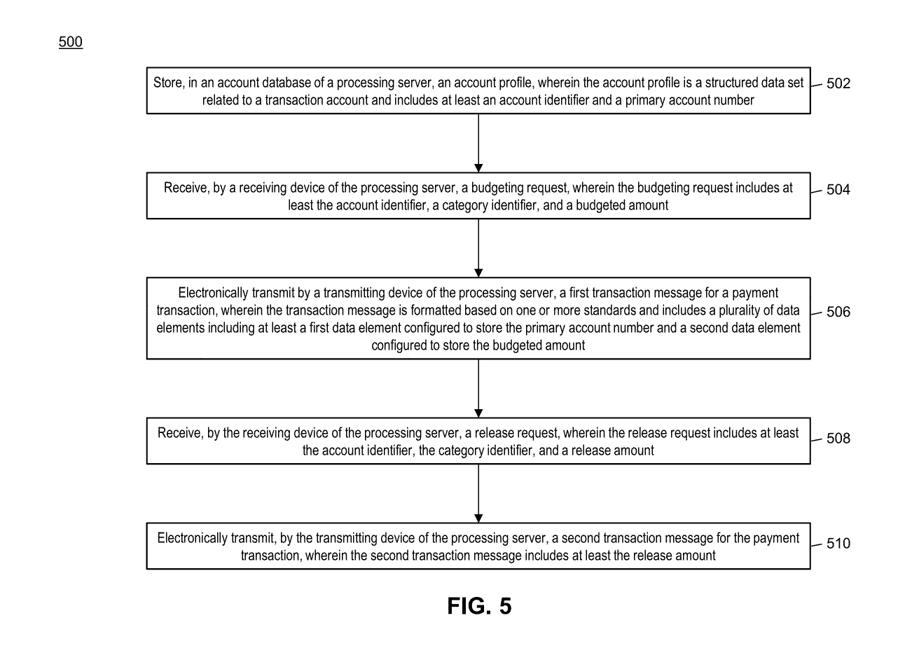

FIG. 5 illustrates a method 500 for the use of envelope-based budgeting for a transaction account performed via the use of authorization holds placed on the transaction account.

In step 502, an account profile (e.g., an account profile 208) may be stored in an account database (e.g., the account database 206) of a processing server (e.g., the processing server 102), wherein the account profile is a structured data set related to a transaction account and includes at least an account identifier and a primary account number. In step 504, a budgeting request may be received by a receiving device (e.g., the receiving device 202) of the processing server, wherein the budgeting request includes at least the account identifier, a category identifier, and a budgeted amount.

In step 506, a first transaction message for a payment transaction may be electronically transmitted by a transmitting device (e.g., the transmitting device 220) of the processing server, wherein the transaction message is formatted based on one or more standards and includes a plurality of data elements including at least a first data element configured to store the primary account number and a second data element configured to store the budgeted amount. In step 508, a release request may be received by the receiving device of the processing server, wherein the release request includes at least the account identifier, the category identifier, and a release amount. In step 510, a second transaction message may be electronically transmitted by the transmitting device of the processing server for the payment transaction, wherein the second transaction message includes at least the release amount.

In one embodiment, the second transaction message may further include the primary account number. In some embodiments, the method 500 may further include receiving, by the receiving device of the processing server, a third transaction message for the payment transaction, wherein the transaction message is formatted based on one or more standards and includes a plurality of data elements including at least a data element configured to store a response code indicating approval of the payment transaction. In a further embodiment, the plurality of data elements included in the third transaction message may further include a data element configured to store a transaction identifier, and the second transaction message may further include the transaction identifier.

In one embodiment, the method 500 may also include executing, by a querying module (e.g., the querying module 214) of the processing server, a query on the account database to update the account profile to include at least the budgeted amount and the category identifier. In some embodiments, the method 500 may further include electronically transmitting, by the transmitting device of the processing server, a data signal to a computing device (e.g., the computing device 110) associated with the account profile, wherein the data signal includes at least a confirmation of transmission of the second transaction message and the release amount. In a further embodiment, the budgeting request may be received from the computing device.

In one embodiment, if the release amount is less than the budgeted amount, the method 500 may also include electronically transmitting, by the transmitting device of the processing server, a third transaction message for a second payment transaction, wherein the third transaction message is formatted based on one or more standards and includes a plurality of data elements including at least a first data element configured to store the primary account number and a second data element configured to store a difference between the budgeted amount and the release amount. In some embodiments, the method 500 may further include repeating, by the processing server, the receiving and electronically transmitting steps for a second category identifier. In one embodiment, the budgeting request may include a predetermined period of time, and the second transaction message may be electronically transmitted after the predetermined period of time.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the processing server 102, individual 104, issuing institution 106, payment card 108, point of sale device 112, acquiring institution 114, payment network 116, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3 and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8583 or 20022 standards. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8583 or 20022 standards and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 5, and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for account budgeting via authorization holds. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for account budgeting via authorization holds, comprising:
storing, in an account database of a processing server, an account profile, wherein the account profile is a structured data set related to a transaction account and includes at least an account identifier and a primary account number;
receiving, by a receiving device of the processing server, a budgeting request, wherein the budgeting request includes at least the account identifier, a category identifier, and a budgeted amount;
electronically transmitting, by a transmitting device of the processing server, a first transaction message for a payment transaction, wherein the transaction message is formatted based on one or more standards and includes a plurality of data elements including at least a first data element configured to store the primary account number and a second data element configured to store the budgeted amount;
receiving, by the receiving device of the processing server, a release request, wherein the release request includes at least the account identifier, the category identifier, and a release amount; and
electronically transmitting, by the transmitting device of the processing server, a second transaction message for the payment transaction, wherein the second transaction message includes at least the release amount.

2. The method of claim 1, wherein the second transaction message further includes the primary account number.

3. The method of claim 1, further comprising:
receiving, by the receiving device of the processing server, a third transaction message for the payment transaction, wherein the transaction message is formatted based on one or more standards and includes a plurality of data elements including at least a data element configured to store a response code indicating approval of the payment transaction.

4. The method of claim 3, wherein
the plurality of data elements included in the third transaction message further includes a data element configured to store a transaction identifier, and
the clearing record further includes the transaction identifier.

5. The method of claim 1, further comprising:
executing, by a querying module of the processing server, a query on the account database to update the account profile to include at least the budgeted amount and the category identifier.

6. The method of claim 1, further comprising:
electronically transmitting, by the transmitting device of the processing server, a data signal to a computing device associated with the account profile, wherein the data signal includes at least a confirmation of transmission of the second transaction message and the release amount.

7. The method of claim 6, wherein the budgeting request is received from the computing device.

8. The method of claim 1, wherein, if the release amount is less than the budgeted amount, the method further comprises:
electronically transmitting, by the transmitting device of the processing server, a third transaction message for a second payment transaction, wherein the third transaction message is formatted based on one or more standards, and includes a plurality of data elements including at least a first data element configured to store the primary account number and a second data element configured to store a difference between the budgeted amount and the release amount.

9. The method of claim 1, further comprising:
repeating, by the processing server, the receiving and electronically transmitting steps for a second category identifier.

10. The method of claim 1, wherein
the budgeting request includes a predetermined period of time, and
the second transaction message is electronically transmitted after the predetermined period of time.

11. A system for account budgeting via authorization holds, comprising:
an account database of a processing server configured to store an account profile, wherein the account profile is a structured data set related to a transaction account and includes at least an account identifier and a primary account number;
a receiving device of the processing server configured to receive a budgeting request, wherein the budgeting request includes at least the account identifier, a category identifier, and a budgeted amount; and
a transmitting device of the processing server configured to electronically transmit a first transaction message for a payment transaction, wherein the transaction message is formatted based on one or more standards, and includes a plurality of data elements including at least a first data element configured to store the primary account number and a second data element configured to store the budgeted amount, wherein
the receiving device of the processing server is further configured to receive a release request, wherein the release request includes at least the account identifier, the category identifier, and a release amount, and
the transmitting device of the processing server is further configured to electronically transmit a second transaction message for the payment transaction, wherein the second transaction message includes at least the release amount.

12. The system of claim 11, wherein the second transaction message further includes the primary account number.

13. The system of claim 11, wherein the receiving device of the processing server is further configured to receive a third transaction message for the payment transaction, wherein the transaction message is formatted based on one or more standards and includes a plurality of data elements including at least a data element configured to store a response code indicating approval of the payment transaction.

14. The system of claim 13, wherein
the plurality of data elements included in the third transaction message further includes a data element configured to store a transaction identifier, and
the second transaction message further includes the transaction identifier.

15. The system of claim 11, further comprising:
a querying module of the processing server configured to execute a query on the account database to update the account profile to include at least the budgeted amount and the category identifier.

16. The system of claim 11, wherein the transmitting device of the processing server is further configured to electronically transmit a data signal to a computing device associated with the account profile, wherein the data signal includes at least a confirmation of transmission of the second transaction message and the release amount.

17. The system of claim 16, wherein the budgeting request is received from the computing device.

18. The system of claim 11, wherein, if the release amount is less than the budgeted amount, the transmitting device of the processing server is further configured to electronically transmit a third transaction message for a second payment transaction, wherein the third transaction message is formatted based on one or more standards, and includes a plurality of data elements including at least a first data element configured to store the primary account number and a second data element configured to store a difference between the budgeted amount and the release amount.

19. The system of claim 11, wherein the processing server is configured to repeat the receiving and electronically transmitting steps for a second category identifier.

20. The system of claim 11, wherein
the budgeting request includes a predetermined period of time, and
the second transaction message is electronically transmitted after the predetermined period of time.
